(19) United States
(12) Patent Application Publication
(10) Pub. No.: US 2002/0062597 A1
(43) Pub. Date: May 30, 2002

(54) Removable draft excluder device

(76) Inventor: Steve Heroux, South Burlington, VT (US)

Correspondence Address: Thomas L. Kautz, HOLLAND & KNIGHT LLP, One East Broward Blvd, Fort Lauderdale, FL, 33301, US

(21) Appl. No.: 09/886,015

(22) Filed: Jun. 22, 2001

Related U.S. Application Data
(63) Continuation-in-part of application No. 09/725,306, filed on Nov. 29, 2000, now abandoned.

(51) Int. Cl. E06B 7/16

(52) U.S. Cl. 49/472; 49/70

(57) ABSTRACT

A removable draft excluder device for sealing a longitudinal gap between a bottom edge of a door and the underlying floor includes an elongated flexible body to wrap the bottom edge and having a base section that engages the gap and joins two longitudinal hollowed sleeve members integrally and laterally protruding from the same on opposite sides of the gap, and two elongated blocking members that slidably and fully engage a respective one of the sleeve members. The blocking members have a length and a cross-section perimeter to continuously close off the gap on a respective side of the bottom edge. The body has a closed first and an opened second ends with a length being slightly longer than the length of the blocking members. The second end folds over the body to close off the sleeve members to essentially reduce the length of the body to the length of the blocking members inserted therein.

### CROSS-REFERENCE TO RELATED APPLICATION

This application is a Continuation-In-Part (C.I.P.) of co-pending patent application Ser. No. 09/725,306, filed on Nov. 29, 2000 now abandoned.

### FIELD OF THE INVENTION

The present invention relates to a seal device and, more particularly, to a removable draft exclude device for protecting against cold drafts or the like by creating a seal to close the gap between a door and its underlying floor.

### BACKGROUND OF THE INVENTION

The need to create a thermal barrier at the base portion of doorway is a continuing pursuit in the construction industry. Various patents have been issued for devices that are directly attached to the door or the threshold base and act to inhibit the flow of cold or warm air, moisture or dust into the open space of the room.

The early 1900 saw the evolution of a number of devices that essentially acted as rain guards. These were generally metallic in nature and required the installation of the device on the door, frame or both. U.S. Pat. No. 16,341 granted to Smith on Jan. 6, 1857, U.S. Pat. No. 641,139 granted to Ogan on Jan. 9, 1900, U.S. Pat. No. 924,434 granted to Cox on Jun. 8, 1909, U.S. Pat. No. 2,202,482 granted to Dahl on May 8, 1940, U.S. Pat. No. 2,565,393 granted to Oswald on Aug. 21, 1951 and U.S. Pat. No. 2,786,244 granted to Rapin on Mar. 26, 1957 all show the evolution of the weather strip from its most basic form to the more sophisticated versions. More recently, the mechanisms disclosed in the patents became more sophisticated.

U.S. Pat. No. 5,001,865 issued on Mar. 26, 1991 to Procton shows a molded threshold seal with a compressible member which must be installed into a stationary threshold base to create a weather seal. U.S. Pat. No. 5,083,400 granted Jan. 28, 1992 to Bowman discloses a device that uses a cylindrical tube that fits into a slot cut into the base of the door. The cylindrical tube is self-leveling and regulated by pistons.

U.S. Pat. No. 5,469,665 granted on Nov. 28, 1995 to Biebuyck discloses the creation of a seal by bringing together two interlocking plate and their associated flaps. One of the plates has to be permanently attached to the doorframe while the other is attached to the threshold frame.

All of the above mentioned inventions require permanent installation, which entails drilling of the door, base portion or both. There is then a high cost associated with the installation procedure. Past inventions must be up kept and adjusted by a professional at regular intervals. Furthermore there is an added expense in the replacement of the unit as it wears down and all of the above-mentioned devices are not generally intended for doors other than those facing the outside.

Other prior art documents such as U.S. Pat. Nos. 4,765,094 to Gemmell and 5,475,948 to Parke and published patent applications 1,079,667 to Stow, 2,238,069 to Paget and 2,255,121 to Smith et al. of the United Kingdom disclose draught excluders without any length adjustable blocking members for adapting to the width of the door and/or elongated sleeve members, receiving the blocking members, adapted to partially fold under the door for enhanced sealing effect of the excluder.

### OBJECTS OF THE INVENTION

It is therefore a general object of the present invention to provide a removable draft excluder device that obviates the above noted disadvantages.

Another object of the present invention is to provide a removable draft excluder device that can easily be installed.

A further object of the present invention is to provide a removable draft excluder device that can easily be removed for convenience of the consumer on per need basic and reinstalled at any other location.

Still another object of the present invention is to provide a removable draft excluder device that is manufactured at a minimum cost.

Still a further object of the present invention is to provide a removable draft excluder device that can simultaneously guard air gaps between a door and its respective floor from both sides of the door.

Yet another object of the present invention is to provide a removable draft excluder device that can be adjusted to the width of the door.

Yet a further object of the present invention is to provide a removable draft excluder device that have deformable sleeve members partially entering into the gap under the bottom of the door to improve the seal thereat.

Other objects and advantages of the present invention will become apparent from a careful reading of the detailed description provided herein, with appropriate reference to the accompanying drawings.

### SUMMARY OF THE INVENTION

According to one aspect of the present invention, there is provided a removable draft excluder device for sealing a longitudinal gap between a bottom edge of a door and a floor therebeneath, said device comprises an elongated flexible body for substantially wrapping said bottom edge and having a base section for longitudinally engaging said gap and joining two longitudinal hollowed sleeve members integrally and laterally protruding therefrom on opposite sides of said gap, and two elongated blocking members slidably and fully engaging a respective one of said sleeve members and having a length and a cross-section perimeter for essentially continuously closing off said gap on a respective side of said bottom edge, said body having a first and a second ends with a length being slightly longer than said length of said blocking members, said sleeve members being closed at said first end of said body, said second end folding over said body to close off a free opening of said sleeve members, thereby essentially reducing said length of said body to said length of said blocking members being inserted therein.

Preferably, the body includes at least one fastener member fastening said second end of said body to the same when in folded configuration.

Preferably, the blocking members are adjustable in length to essentially fit to a width of said door.

Preferably, the fastener member being a hook and loop type fastener, thereby allowing for an adjustable position of said second end relative to said body when in folded configuration depending on said length of said blocking members.

Preferably, the body is made out of a fabric material, such as a plastic type material, thereby improving sliding of said body relative to said floor.

Preferably, the fabric material is stretchable in a direction from one of said sleeve members to the other.

Preferably, the distance between said sleeve members being substantially equal to a thickness of said door.

According to a second aspect of the present invention, there is provided a removable draft excluder device for sealing a longitudinal gap between a bottom edge of a door and a floor therebeneath, said device comprises an elongated flexible body for substantially wrapping said bottom edge and having a base section for longitudinally engaging said gap and joining two longitudinal hollowed sleeve members integrally and laterally protruding therefrom on opposite sides of said gap, and two elongated blocking members slidably and adjustably engaging a respective one of said sleeve members and having a length and a cross-section perimeter for essentially continuously closing off said gap on a respective side of said bottom edge, said cross-section perimeter of said blocking members being substantially smaller than a cross-section perimeter of said sleeve members, whereby a first portion of said cross-section perimeter of at least one of said sleeve members substantially freely assuming part of said cross-section perimeter of said blocking member and a second portion of the same for being located in said gap and closing off the same when keeping said blocking member tight against said bottom edge and said floor.

Preferably, the base section has a width separating both of said sleeve members away from each other, said width being so dimensioned that a first portion of said cross-section perimeter of each one of said sleeve members substantially freely assuming part of said cross-section perimeter of a respective one of said blocking members and a second portion of the same for being located in said gap and closing off the same when keeping said blocking members tight against said bottom edge and said floor.

Alternatively, one of said blocking members having a longitudinally variable cross-section shape.

Preferably, the one of said blocking members being a plurality of different pieces equally spaced along said length of said body.

### BRIEF DESCRIPTION OF THE DRAWINGS

In the annexed drawings, like reference characters indicate like elements throughout.

FIG. 1 is a perspective view of an embodiment of a removable draft excluder device according to the present invention;

FIG. 2 is a perspective view showing the embodiment FIG. 1 being installed on under the bottom edge of a door;

FIG. 3 is a section view taken along line 3-3 of FIG. 2;

FIG. 4 is a view similar to FIG. 1, showing a second embodiment of a removable draft excluder device according to the present invention with one of the blocking members to be housed into a sleeve member of the flexible body;

FIG. 5 is a sectional view taken along line 5-5 of FIG. 4;

FIGS. 5a and 5b are perspective section views, showing a folding procedure of the embodiment of FIG. 4;

FIG. 6 is a view similar to FIG. 2, showing the embodiment of FIG. 4 being inserted with the folding part first and up under the bottom edge of a door; and

FIG. 7 is a view similar to FIG. 1, showing a third embodiment of a removable draft excluder device according to the present invention with different base section of the body and blocking members.

### DETAILED DESCRIPTION OF THE PREFERRED EMBODIMENTS

With reference to the annexed drawings preferred embodiments of the present invention will be herein described for indicative purposes and by no means as of limitation.

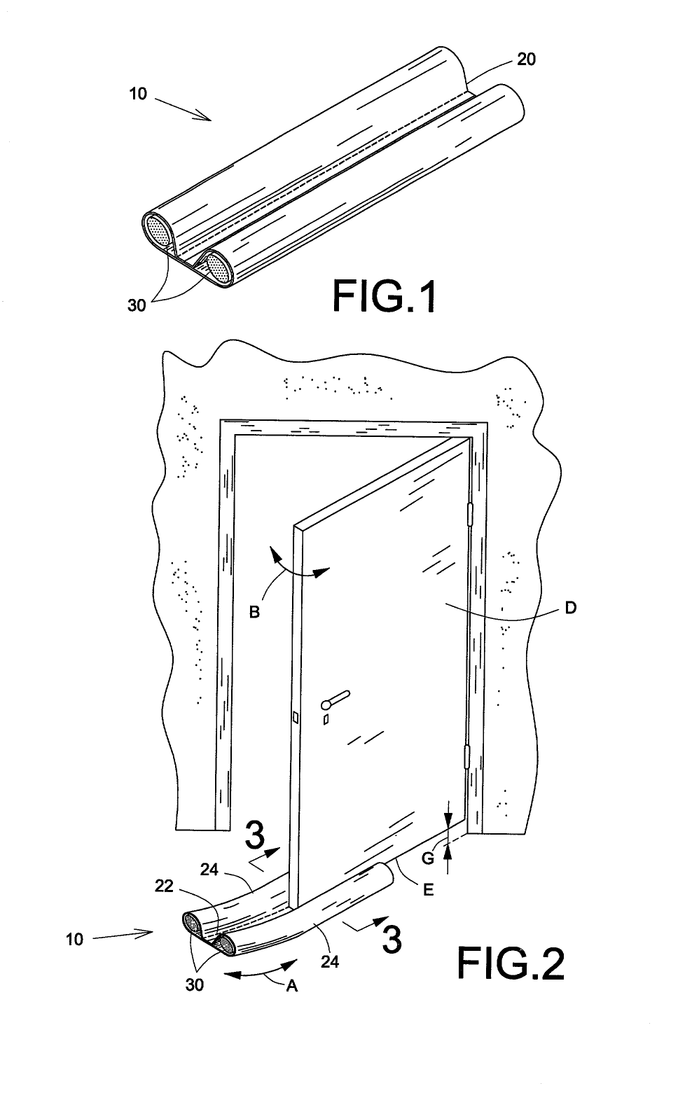

Referring to FIGS. 1 to 3 there is shown a first embodiment 10 of a removable draft excluder device according to the present invention which is adapted for substantially closed at least one side of a longitudinal gap G between a bottom edge E of a door D and a floor F therebeneath without being secured to the door D. The device 10 is sizable to fit different door D widths as draft guard and follows the door D along arrow B by sliding on the floor F when the door D pivots around its mounting hinges (see FIG. 2).

The device 10 includes an elongated flexible body 20 used for substantially wrapping the bottom edge E of the door D. The body 20 has a base section 22 that longitudinally engages the gap G and joins two longitudinal hollowed sleeve members 24 integrally and laterally protruding from the base member 22 on opposite sides of the gap G. The body 20 also includes two blocking members 30, each one slides to substantially fully engage (as shown by arrow C in FIG. 4) a respective sleeve member 24 and has a length and a cross-section perimeter that allow to essentially continuously close off the gap G on its respective side of the bottom edge E all along its length.

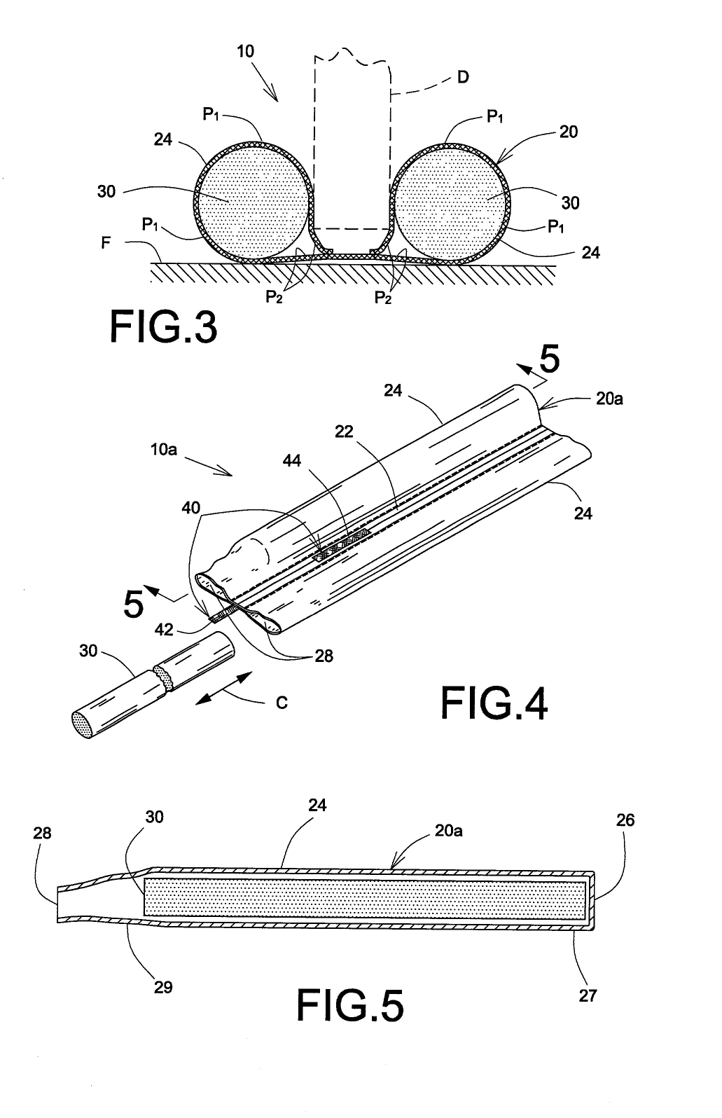

The cross-section perimeter of each blocking member 30 is substantially smaller than the cross-section perimeter of its respective sleeve member 24 such that it adjustably and loosely fits therein. When the device 10 is inserted through the gap G as shown in FIG. 2, a first portion P1 of the cross-section perimeter of at least one of the sleeve members 24 substantially freely assumes part of the cross-section perimeter of the blocking member 30 outside of the gap G and a second portion P2 of the same 24 is located inside the gap G and closes off the same when the blocking member 30 is kept tight against the bottom edge E and the floor F as illustrated in FIG. 3.

The sleeve members 24 are formed via stitches or the like on the material of the body 20, as represented by dashed lines in FIGS. 1, 2, 4 and 5a to 7. Alternatively, each sleeve member 24 could be openable and closable using a Velcro™ tape or the like (not shown) instead of stitches.

Preferably, the blocking members 30 and the body 20 are of a length approximately equal to the width of the door D.

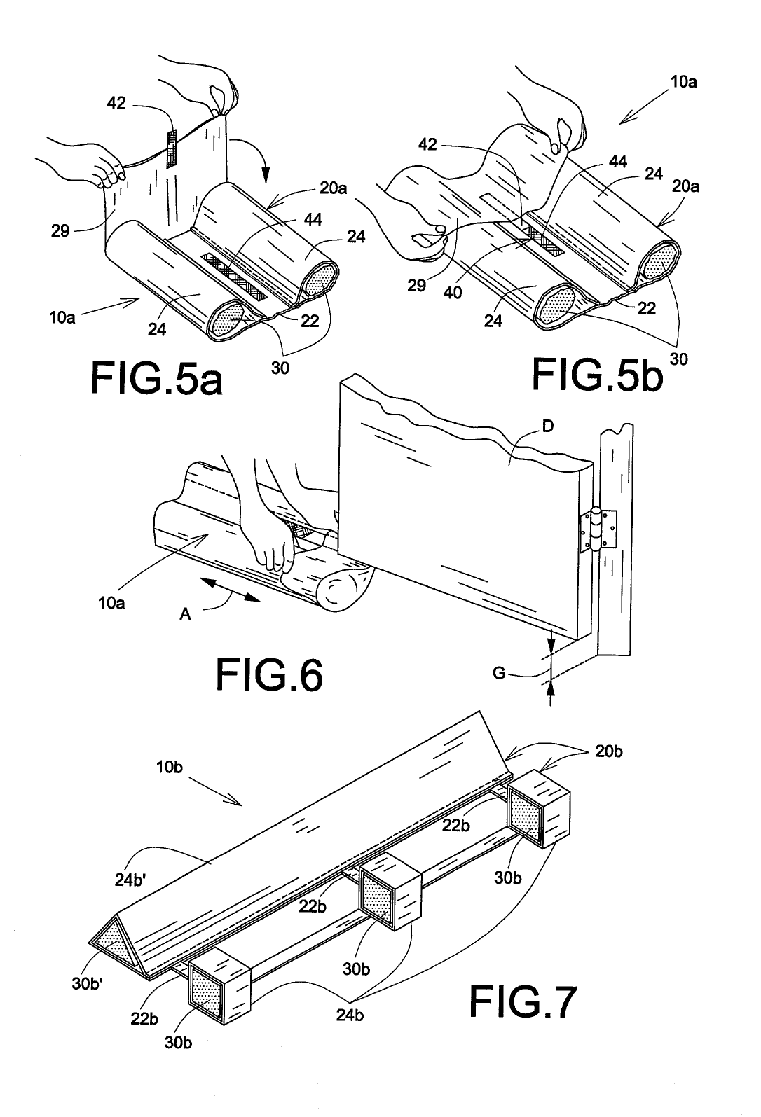

Referring to FIGS. 4 and 5, there is shown a second embodiment 10a of a removable draft excluder device according to the present invention in which each blocking member 30 fully engages its respective sleeve member 24. The latter has a closing 26 on a first end 27 of the body 20a and a free opening 28 on a second end 29 of the same 20a for receiving each blocking member 30 there through.

Accordingly, the body 20a is of a length slightly longer than the length of the blocking members to enable to fold the second end 29 over the same 20a for closing the free opening 28 and to releasably secure the blocking member 30 inserted therein. (see FIGS. 5a and 5b). This folding essentially reduces the length of the body 20a to the length of said blocking members 30 and the width of the door D.

As shown in FIGS. 4, 5a and 5b, the body 20a has at least one fastening member 40 preferably in the form of a hook 42 and loop 44 type fastener, commonly known as Velcro™ tape. Preferably, the hook part 42 is secured to an extremity of the base section 22 at the second end 29 of the body 20a while the loop part 44 is secured along the base 22 in proximity to the second end 29 of the body 20a for adjustably secure that hook part 42 thereto when the second end 29 is in the folded configuration (see FIG. 5b).

The body 20a can be made out of different fabric materials that could be either water impermeable and/or thermally insulating. The material could also be stretchable, especially in a direction from one sleeve member 24 to the other so as to have the bottom edge E of the door D clamped (or sandwiched) between the two blocking members 30, as shown in FIG. 3. Preferably, the material is a plastic type material to improve the sliding of the device 10, 10a relative to the floor F.

Preferably, the distance between the two sleeve members 24 is substantially equal to or slightly smaller than the thickness of the door D.

The blocking members 30 have an elliptical, preferably circular, cross-section shape (see FIG. 3) or any different polygonal cross-section shapes, as illustrated on a third embodiment 10b of a removable draft excluder device according to the present invention of FIG. 7 with preferably foam type insulators 30b, 30b′ and respective sleeve members 24b, 24b′. Additionally, as shown in FIG. 7, one of the insulator 30b could have a plurality of sections spread along the bottom edge E and be covered by a corresponding sleeve member 24b. Furthermore, the base section 22b of the main body 20b of the third embodiment 10b could have a plurality of base subsections substantially parallel and adjacent to each other along the bottom edge E. Obviously, it is also possible that insulators 30b, 30b′ have different shapes from each other.

Obviously, the blocking members 30 could alternatively be inflatable (not shown), telescopic for length adjustment (not shown), or even have a longitudinally variable cross-section shape.

The device 10, 10a, 10b of the present invention is adaptable to the width of the door D and can be easily removed from the bottom edge E of a door and be reinstalled under another door D.

The length of the blocking members 30 is adjusted or cut according to the width dimension of the door D by using ordinary scissors or the like. Once properly cut, the blocking members 30, ready for installation, are inserted into each sleeve member 24 (see FIGS. 1, 4, 5 and 7). Now the installer only needs to fold the second end 29 of the main body 20 over the same (see FIG. 5a) and to secure the fastening member 40 (see FIG. 5b).

Referring to FIGS. 2 and 6, the device 10, 10a is slidably inserted in or out of the gap G between the bottom edge E of the door D and the floor F, as shown by arrow A. The device 10a preferably slides under the door D with the folding part first and up against the bottom edge E of the door D, as illustrated in FIG. 6. Obviously, the device 10, 10a follows the door D during its pivoting motion by sliding onto the floor F, along arrow B.

Although the present removable draft excluder device has been described with a certain degree of particularity it is to be understood that the disclosure has been made by way of example only and that the present invention is not limited to the features of the embodiments described and illustrated herein, but includes all variations and modifications within the scope and spirit of the invention as hereinafter claimed.

I claim:

1. A removable draft excluder device for sealing a longitudinal gap between a bottom edge of a door and a floor therebeneath, said device comprising an elongated flexible body for substantially wrapping said bottom edge and having a base section for longitudinally engaging said gap and joining two longitudinal hollowed sleeve members integrally and laterally protruding therefrom on opposite sides of said gap, and two elongated blocking members slidably and fully engaging a respective one of said sleeve members and having a length and a cross-section perimeter for essentially continuously closing off said gap on a respective side of said bottom edge, said body having a first and a second ends with a length being slightly longer than said length of said blocking members, said sleeve members being closed at said first end of said body, said second end folding over said body to close off a free opening of said sleeve members, thereby essentially reducing said length of said body to said length of said blocking members being inserted therein.

2. A device as defined in claim 1, wherein said body including at least one fastener member fastening said second end of said body to the same when in folded configuration.

3. A device as defined in claim 2, wherein said blocking members are adjustable in length to essentially fit to a width of said door.

4. A device as defined in claim 2, wherein said fastener member being a hook and loop type fastener, thereby allowing for an adjustable position of said second end relative to said body when in folded configuration depending on said length of said blocking members.

5. A device as defined in claim 1, wherein each one of said elongated blocking members fully engaging a respective one of said sleeve members, said cross-section perimeter of said blocking members being substantially smaller than a cross-section perimeter of said sleeve members, whereby a first portion of said cross-section perimeter of at least one of said sleeve members substantially freely assuming part of said cross-section perimeter of said blocking member and a second portion of the same for being located in said gap and closing off the same when keeping said blocking member tight against said bottom edge and said floor.

6. A device as defined in claim 1, wherein said body being made out of a fabric material.

7. A device as defined in claim 6, wherein said fabric material being a water impermeable material.

8. A device as defined in claim 6, wherein said fabric material being a plastic type material, thereby improving sliding of said body relative to said floor.

9. A device as defined in claim 6, wherein said fabric material being stretchable in a direction from one of said sleeve members to the other.

10. A device as defined in claim 1, wherein a distance between said sleeve members being substantially equal to a thickness of said door.

11. A removable draft excluder device for sealing a longitudinal gap between a bottom edge of a door and a floor therebeneath, said device comprising an elongated flexible body for substantially wrapping said bottom edge and having a base section for longitudinally engaging said gap and joining two longitudinal hollowed sleeve members integrally and laterally protruding therefrom on opposite sides of said gap, and two elongated blocking members slidably and adjustably engaging a respective one of said sleeve members and having a length and a cross-section perimeter for essentially continuously closing off said gap on a respective side of said bottom edge, said cross-section perimeter of said blocking members being substantially smaller than a cross-section perimeter of said sleeve members, whereby a first portion of said cross-section perimeter of at least one of said sleeve members substantially freely assuming part of said cross-section perimeter of said blocking member and a second portion of the same for being located in said gap and closing off the same when keeping said blocking member tight against said bottom edge and said floor.

12. A device as defined in claim 11, wherein said blocking members are adjustable in length to essentially fit to a width of said door.

13. A device as defined in claim 11, wherein said base section having a width separating both of said sleeve members away from each other, said width being so dimensioned that a first portion of said cross-section perimeter of each one of said sleeve members substantially freely assuming part of said cross-section perimeter of a respective one of said blocking members and a second portion of the same for being located in said gap and closing off the same when keeping said blocking members tight against said bottom edge and said floor.

14. A device as defined in claim 13, wherein said blocking members and said main body being of a length approximately equal to a length of said gap.

15. A device as defined in claim 11, wherein one of said blocking members having a longitudinally variable cross-section shape.

16. A device as defined in claim 15, wherein said one of said blocking members being a plurality of different pieces equally spaced along said length of said body.

17. A device as defined in claim 11, wherein said body being made out of a fabric material.

18. A device as defined in claim 17, wherein said fabric material being a plastic type material, thereby improving sliding of said body relative to said floor.

19. A device as defined in claim 17, wherein said fabric material being stretchable in a direction from one of said sleeve members to the other.
